(19) United States
(12) Patent Application Publication
(10) Pub. No.: US 2025/0062358 A1
(43) Pub. Date: Feb. 20, 2025

(54) SELF-STANDING FILM LAMINATE FOR ANODE OF LITHIUM SECONDARY BATTERY, AND METHOD FOR MANUFACTURING THE SAME

(71) Applicants: Hyundai Motor Company, Seoul (KR); Kia Corporation, Seoul (KR)

(72) Inventors: Ju Young Jang, Goyang (KR); Byung Yong Lee, Anyang (KR)

(21) Appl. No.: 18/511,019

(22) Filed: Nov. 16, 2023

(30) Foreign Application Priority Data
Aug. 14, 2023 (KR) 10-2023-0106488

(51) Int. Cl. H01M 4/62; H01M 4/13; H01M 4/36

(52) U.S. Cl. CPC H01M 4/623; H01M 4/13; H01M 4/366; H01M 2004/021; H01M 2004/027

(57) ABSTRACT

The present invention provides a self-standing film laminate for an anode of a lithium secondary battery, the self-standing film laminate including a first self-standing film including a first anode active material, a first conductive material, and a first binder containing a triblock copolymer, and a second self-standing film including a second anode active material, a second conductive material, and a second binder containing a fluorine-based resin, wherein the triblock copolymer includes a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder is in the form of a non-continuous column connecting between any one of a domain of the first anode active material or a domain of the first conductive material and another one of a domain of the first anode active material or a domain of the first conductive material.

### CROSS-REFERENCE TO RELATED APPLICATIONS

This application claims the priority of Korean Patent Application No. 10-2023-0106488 filed on Aug. 14, 2023, in the Korean Intellectual Property Office, the disclosure of which is incorporated herein by reference.

### BACKGROUND

### Field

The present invention relates to a self-standing film laminate for an anode of a lithium secondary battery, using a binder including a triblock copolymer containing a soft block and a hard block, and a method for manufacturing the same.

### Background

Lithium secondary batteries, since their first commercialization in the 1990s, have been widely applied in the portable electronics market, and have been subjected to continuous interest as the most researched energy storage systems. As lithium secondary batteries provided with features such as high driving voltage, high energy density, low self-discharge rate, high rate performance, and long cycle stability, the lithium secondary batteries satisfy conditions required to be suitable as an energy source for electric vehicles.

Still, the lithium secondary batteries applied to electric vehicles are left with three major issues: safety, service time, and costs. The issues of safety and service time may be resolved using solid-state batteries, and yet the issue of contributes to hindering the extensive application of lithium secondary batteries, and thus a great deal of research is underway to reduce the costs of lithium secondary batteries.

Reducing energy consumption required for manufacturing or increasing electrode thickness is one of the most effective ways to reduce the manufacturing costs of lithium secondary batteries. In typical methods for manufacturing an electrode, a current collector is cast with a slurry in which an electrode active material, a polymer binder, and a conductive additive are mixed in water or an organic solvent and the resulting product is dried and pressed to form an electrode, but in this way, the energy required to manufacture the slurry and coat the current collector takes up about 50% of the energy consumed over the entire manufacturing process, and thus research has been done into a process for manufacturing dry electrodes without solvents to reduce the manufacturing costs of lithium secondary batteries.

Despite the fact that much research has been conducted on the methods for manufacturing dry electrodes, the development of dry electrodes having excellent mechanical properties, an elongation rate that is not excessively high to facilitate scale-up for mass production, excellent adhesion of a self-standing film to a current collector, and high flexibility has not been successful yet, and this requires further research and development.

### SUMMARY

An aspect of the present invention provides a self-standing film laminate for an anode of a lithium secondary battery, which is provided with excellent mechanical properties, satisfactory elongation, excellent adhesion to a current collector, and excellent flexibility, and a method for manufacturing the same.
In one aspect, a self-standing film laminate suitable for an anode of a lithium secondary battery is provided, the self-standing film laminate comprising (i) a first self-standing film comprising a) a first anode active material, b) a first conductive material, and c) a first binder comprising a triblock copolymer; and (ii) a second self-standing film comprising a) a second anode active material, b) a second conductive material, and c) a second binder comprising a fluorine-based resin, wherein the triblock copolymer comprises a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder comprises any one of i) a domain of the first anode active material or ii) a domain of the first conductive material and a) another one of a domain of the first anode active material or b) a domain of the first conductive material.

In a further aspect, there is provided a self-standing film laminate for an anode of a lithium secondary battery, wherein the self-standing film laminate includes a first self-standing film including a first anode active material, a first conductive material, and a first binder containing a triblock copolymer, and a second self-standing film including a second anode active material, a second conductive material, and a second binder containing a fluorine-based resin. In this case, the triblock copolymer may include a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder may be in the form of a non-continuous column connecting between any one of a domain of the first anode active material or a domain of the first conductive material and another one of a domain of the first anode active material or a domain of the first conductive material.

According to another aspect of the present invention, there are provided an anode for a lithium secondary battery including the self-standing film laminate for an anode of a lithium secondary battery, a lithium secondary battery including the anode for a lithium secondary battery, a method for manufacturing the self-standing film laminate for an anode of a lithium secondary battery, and a method for manufacturing the anode for a lithium secondary battery.

In aspects, in a self-standing film laminate as disclosed herein, suitably the first self-standing film and the second self-standing film are at a thickness ratio of 1:0.01 to 1:0.49.

In aspects, in a self-standing film laminate as disclosed herein, suitably the film laminate comprises a tri-layer structure in which the first self-standing film is stacked on each of an upper side and a lower side of the second self-standing film.

In aspects, in a self-standing film laminate as disclosed herein, suitably the film laminate comprises a repeated alternating stack structure of the first self-standing film and the second self-standing film.

In aspects, in a self-standing film laminate as disclosed herein, suitably the domain of the first anode active material or the domain of the first conductive material and the first binder which is in the form of a non-continuous column are connected to form a three-dimensional network structure.

In aspects, in a self-standing film laminate as disclosed herein, suitably the first binder has an average width perpendicular to a longitudinal direction of 0.1 μm to 2 μm.

In aspects, in a self-standing film laminate as disclosed herein, a suitably first glass transition temperature and a second glass transition temperature each corresponding to the first hard block and the second hard block are independently 50° C. to 120° C., and a third glass transition temperature corresponding to the soft block is −120° C. to −50° C.

In aspects, in a self-standing film laminate as disclosed herein, suitably the soft block is derived from an aliphatic diene-based monomer comprising at least one selected from the group consisting of a butadiene-based monomer, a pentadiene-based monomer, and a hexadiene-based monomer.

In aspects, in a self-standing film laminate as disclosed herein, suitably the first hard block and the second hard block are each independently derived from an aromatic ring-containing ethylenically unsaturated monomer comprising at least one of a styrene-based monomer and an aromatic (meth)acryl-based monomer.

In an aspect, provided is a negative electrode of a lithium secondary battery that includes the composition as described herein.

In an aspect, provided is a lithium secondary battery including the negative electrode as described herein.

In an aspect, provided is a vehicle including the lithium secondary battery as described herein.

The term “self-standing” as used herein refers to a sheet in the form that can be handled as an independent sheet without the assistance of a substrate or support. Thus, the term “self-standing” may have the same meaning as “self-supporting”.

A term “all-solid-state battery” as used herein includes or refers to a rechargeable battery (including a secondary battery) that includes an electrolyte in a solid state, e.g., gel or polymer (cured), which may include an ionomer and other electrolytic components for transferring ions between the electrodes of the battery. In certain aspect, a lithium secondary battery as referred to herein is an all-solid state battery.

As referred to herein, a rubber phase or state is above the T_{g}, (glass transition temperature) of the material, i.e. where the material may be in a more rubber state, and comparatively soft and flexible. Thus, when stated herein that the material forms a forming a rubbery phase at room temperature (e.g. 25° C.), the material may be above its glass transition temperature at room temperature (25° C.) and may in a comparatively rubbery or more flexible state.

As referred to herein, a glass phase or state is below the T_{g}, (glass transition temperature) of the material, and where the material may be in a more rigid or glassy configuration. Thus, when stated herein that the material forms a glass phase at room temperature (e.g. 25° C.), the material may be below its glass transition temperature at room temperature (25° C.) and may in a comparatively rigid or hardened state.

A term “all-solid-state battery” as used herein refers to a rechargeable secondary battery that includes an electrolyte in a solid state, e.g., gel or polymer (cured), which may include an ionomer and other electrolytic components for transferring ions between the electrodes of the battery. In certain aspect, a lithium secondary battery as referred to herein is an all-solid state battery.

The term “self-standing film or laminate or sheet” or other similar term as used herein includes that the film or laminate or sheet can be in the form of a sheet and can be handled as an independent sheet without the assistance of a substrate or support. Thus, the term “self-standing” may have the same meaning as “self-supporting”.

As referred to herein the term “block polymer” includes a polymer comprising two or more chemically distinct regions or segments (referred to as “blocks”) typically joined in a linear manner, e.g. a polymer comprising chemically differentiated units which are joined (covalently bonded) end-to-end with respect to polymerized functionality, rather than in pendent or grafted fashion. In one aspect, a block polymer may comprise (1) a first polymer block comprising at least 5, 10, 20 or 30 first repeating units; and (ii) a second polymer block comprising at least 5, 10, 20 or 30 second repeating units.

As referred to herein, the terms “soft block” and “hard block” indicate that the respective polymer units or portions differ in e.g. in structure and one or more properties. In certain aspects, the soft block may have a lower glass transition temperature or melting temperature (e.g. below room temperature) than a hard block (which may have a glass transition temperature or melting temperature higher (such as above room temperature) than the application temperature of the formed block copolymer material. In certain embodiments, the Tg of hard and soft blocks may differ by e.g. up to or more than e.g. 3° C., 5° C., 10° C., 200° C. or 30° C.

Other aspects are disclosed infra.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A and 1B are SEM images of a first self-standing film according to Manufacturing Example 1-1;

FIG. 1C is a view showing a network structure formed in the self-standing film according to Manufacturing Example 1-1;

FIG. 2A is an SEM image of a composition (mixed powder) for forming a self-standing film before manufacturing the first self-standing film of Manufacturing Example 1-1;

FIG. 2B is an SEM image of SBS powder before manufacturing the mixed powder shown in FIG. 2A;

FIG. 3A is an image taken after evaluating flexibility of a self-standing film laminate of Example 1 according to Experimental Example 3;

FIG. 3B is an image taken after evaluating flexibility of a self-standing film of Comparative Example 1 according to Experimental Example 3; and

FIG. 3C is an image taken after evaluating flexibility of a self-standing film of Reference Example 1 according to Experimental Example 3.

### DETAILED DESCRIPTION OF THE PREFERRED EMBODIMENT

Exemplary embodiments of the present invention will now be described in detail with reference to the accompanying drawings.

Hereinafter, a self-standing film laminate for an anode of a lithium secondary battery and a method for manufacturing the same will be described in detail so that the present invention may be easily carried out by a person skill in the art to which the present invention pertains.

### Self-Standing Film Laminate for Anode of Lithium Secondary Battery

A self-standing film laminate for an anode of a lithium secondary battery of the present invention is a laminate including a first self-standing film and a second self-standing film.

### First Self-Standing Film

The first self-standing film includes a first binder, a first anode active material, and a first conductive material.

The first binder may include a triblock copolymer. In this case, the triblock copolymer may include a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder including the triblock copolymer may be in the form of a non-continuous column connecting between any one of a domain of the first anode active material or a domain of the first conductive material and another one of a domain of the first anode active material or a domain of the first conductive material.

The soft block may contain repeating units derived from aliphatic diene-based monomers and/or cycloaliphatic diene-based monomers and exhibit a rubber phase at room temperature, and specifically may be derived from the aliphatic diene-based monomers containing at least one selected from the group consisting of a butadiene-based monomer, a pentadiene-based monomer, and a hexadiene-based monomer.

The butadiene-based monomer may include at least one selected from the group consisting of 1,2-butadiene, 1,3-butadiene, isoprene, and chloroprene.

The pentadiene-based monomer may include at least one selected from the group consisting of 1,2-pentadiene, 1,3-pentadiene, 1,4-pentadiene, 2,3-pentadiene, 2-methyl-1,3-pentadiene, 2-methyl-1,4-pentadiene, 2-methyl-2,3-pentadiene, 2-methyl-2,4-pentadiene, 3-methyl-1,3-pentadiene, 3-methyl-1,4-pentadiene, 4-methyl-1,3-pentadiene, 2-ethyl-1,3-pentadiene, 2-ethyl-1,4-pentadiene, 2-ethyl-2,4-pentadiene, 3-ethyl-1,3-pentadiene, 3-ethyl-1,4-pentadiene, 4-ethyl-1,3-pentadiene, 1-chloro-1,3-pentadiene, 1-chloro-2,4-pentadiene, 2-chloro-1,3-pentadiene, 3-chloro-1,3-pentadiene, 3-chloro-1,4-pentadiene, and 5-chloro-1,3-pentadiene.

The hexadiene-based monomer may include at least one selected from the group consisting of 1, 2-hexadiene, 1,3-hexadiene, 1,4-hexadiene, 1, 5-hexadiene, 2,3-hexadiene, 2,4-hexadiene, 2, 5-hexadiene, 3,5-hexadiene, 2-methyl-1,3-hexadiene, 2-methyl-1,4-hexadiene, 2-methyl-1, 5-hexadiene, 2-methyl-2,3-hexadiene, 2-methyl-2,4-hexadiene, 3-methyl-1, 2-hexadiene, 3-methyl-1,3-hexadiene, 3-methyl-1,4-hexadiene, 3-methyl-1, 5-hexadiene, 3-methyl-2,4-hexadiene, 3-methyl-2, 5-hexadiene, 4-methyl-1,3-hexadiene, 4-methyl-1,4-hexadiene, 4-methyl-2,3-hexadiene, 5-methyl-1,3-hexadiene, 5-methyl-1,4-hexadiene, 2-ethyl-1,3-hexadiene, 2-ethyl-1,4-hexadiene, 3-ethyl-1, 2-hexadiene, 3-ethyl-1,3-hexadiene, 3-ethyl-1,4-hexadiene, and 3-ethyl-1, 5-hexadiene.

The soft block may serve to provide flexibility to the triblock copolymer and to improve extrusion molding properties and wear resistance.

The first hard block and the second hard block may include a repeating unit derived from an ethylenically unsaturated monomer containing an aromatic ring and exhibit a glass phase at room temperature, and specifically, the aromatic ring contained in the ethylenically unsaturated monomer may be a substituted or unsubstituted benzene ring or a substituted or unsubstituted naphthalene ring.

In addition, the aromatic ring may be connected to a main chain or a side chain of the repeating units of the first hard block and the second hard block, and may preferably be connected to a side chain of the repeating units of the first hard block and the second hard block.

The first hard block and the second hard block may each independently be derived from an aromatic ring-containing ethylenically unsaturated monomer including at least one of a styrene-based monomer and an aromatic (meth)acryl-based monomer.

The styrene-based monomer may include at least one selected from the group consisting of styrene, α-methylstyrene, p-methylstyrene, p-methoxystyrene, p-ethoxystyrene, t-butoxystyrene, p-acetoxystyrene, p-chlorostyrene, p-bromostyrene, 2,4-dimethylstyrene, 3,5-dimethylstyrene, and 2,4,6-trimethylstyrene.

The aromatic (meth)acryl-based monomer may include at least one selected from the group consisting of benzyl acrylate, benzyl methacrylate, phenoxyacrylate, phenoxymethacrylate, phenyl acrylate, phenyl methacrylate, phenylethyl acrylate, and phenylethyl methacrylate.

The first hard block and the second hard block may be strongly bonded to the first anode active material or the first conductive material through pi-pi interactions resulting from to the aromatic ring structure included in the repeating units. In addition, the first hard block and the second hard block may provide high strength properties to the triblock copolymer including the first hard block and the second hard block.

In an embodiment, the first hard block and the second hard block may be in an amount of 10 wt % to 60 wt %, preferably 15 wt % to 55 wt %, more preferably 20 wt % to 50 wt %, with respect to the total amount of the triblock copolymer. When the amount of the first hard block and the second hard block satisfies the numerical range described above, the bonding strength may be further improved due to strong interactions with the first negative active material or the first conductive material, and the triblock copolymer may have appropriate flexibility to be equipped with much superior molding properties.

In an embodiment, the first hard block and the second hard block may each have a weight average molecular weight of 9,000 g/mol to 20,000 g/mol, preferably 9,500 g/mol to 20,000 g/mol, more preferably 10,000 g/mol to 20,000 g/mol. When the weight average molecular weight of each of the first hard block and the second hard block satisfies the numerical range described above, the physical crosslinking power between the first binder and the first anode active material or the first conductive material may be improved to form a more stable three-dimensional network structure, and deformation may be easy in manufacturing electrodes to further improve processability.

The first anode active material may include at least one selected from the group consisting of a carbon-based active material, a silicon-based active material, a metal-based active material that may be alloyed with lithium, and a lithium-containing active material.

The carbon-based active material may be, for example, graphite, hard carbon, soft carbon, or graphene. The graphite may be artificial graphite, natural graphite, a mixture of artificial graphite and natural graphite, natural graphite coated with artificial graphite, or a combination thereof.

The carbon-based active material has a little change in crystal structure in the process of intercalation and deintercalation of lithium ions, and may thus allow continuous and repeated redox reactions at an electrode to obtain a lithium secondary battery having high capacity and greater lifespan.

The silicon-based active material may be, for example, Si, SiOₘ, Si—C composite, Si-Q alloy, or a combination thereof, m satisfies 0<m≤2, Q may be an alkali metal, an alkaline earth metal, Group 13 to Group 16 elements, a transition metal, a rare earth element, or a combination thereof, and Si is excluded from Q.

The metal-based active materials that may be alloyed with lithium may be, for example, B, Al, Ga, In, Ge, Sn, Pb, P, As, Sb, Bi, Mg, Ca, Zn, Cd, Pd, Ag, Au, Pt, an alloy thereof, or an oxide thereof.

The lithium-containing active material may be, for example, lithium-containing titanium complex oxide (LTO).

The first conductive material may include at least one selected from the group consisting of graphite, active carbon, carbon black, acetylene black, Ketjen black, carbon nanotubes, graphene, and carbon fiber.

In an embodiment, any one of a domain of the first anode active material or a domain of the first conductive material and another one of a domain of the first anode active material or a domain of the conductive material may be connected by the first binder in the form of a non-continuous column (or wire) to form a three-dimensional network structure. That is, any one surface of a domain of the first anode active material or the first conductive material and another one surface of a domain of the first anode active material or the first conductive material may be connected by a binder in the form of a non-continuous column (or wire) to form a complex having a three-dimensional network structure in a net shape (the active materials or the conductive materials are located at the intersections, and a linear binder connects the materials).

Such a three-dimensional network structure may result from the strong pi-pi interactions between the first hard block and the second hard block included in the triblock copolymer and the first anode active material or the first conductive material. In this case, the domain of the first anode active material or the domain of the first conductive material and the first binder which is in the form of a non-continuous column may be connected to form a three-dimensional network structure, and accordingly, the first self-standing film may have excellent tensile strength.

In an embodiment, the first binder may have an average width perpendicular to a longitudinal direction of 0.1 μm to 2 μm, preferably 0.2 μm to 0.8 μm, and more preferably 0.3 μm to 0.7 μm. In this case, an average width perpendicular to a longitudinal direction with respect to the first binder in the form of column included in the first self-standing film is a value obtained by measuring a width perpendicular to a longitudinal direction at both ends and at the center along the longitudinal direction with respect to the first binder of five columns selected at random, and taking the average of these measured values, using an image of the first binder particles observed with a scanning electron microscope (SEM).

In an embodiment, the first glass transition temperature and the second glass transition temperature each corresponding to the first hard block and the second hard block may be 50° C. to 120° C., and the third glass transition temperature corresponding to the soft block may be −120° C. to −50° C. Preferably, the first glass transition temperature and the second glass transition temperature may be 80° C. to 120° C. and the third glass transition temperature may be −120° C. to −80° C., more preferably, the first glass transition temperature and the second glass transition temperature may be 80° C. to 110° C. and the third glass transition temperature may be −110° C. to −80° C. As such, the first hard block, the second hard block, and the soft block included in the triblock copolymer have a glass transition temperature in the numerical ranges described above, and accordingly, the first self-standing film including the first binder containing the triblock copolymer may have further improved durability and flexibility and may further maintain the shape more effectively.

The soft block, the first hard block, and the second hard block included in the triblock copolymer may exhibit independent properties without affecting each other, and accordingly, the soft block may provide appropriate flexibility, and the first hard block and the second hard block may each provide a strong bonding strength with the first anode active material or the first binder to the first self-standing film.

### Second Self-Standing Film

The second self-standing film includes a second binder, a second anode active material, and a second conductive material.

The second binder may include a fluorine-based resin. The fluorine-based resin may be in a fibrous form and may serve as a matrix that supports and binds the second anode active material and the second conductive material.

The fluorine-based resin may include, for example, at least one selected from the group consisting of polyvinylidene fluoride (PVDF), polyvinylidene fluoride-hexafluoropropylene (PVDF-HFP), polyvinylidene fluoride-trifluoroethylene (PVDF-TrFE), polyvinylidene fluoride-tetrafluoroethylene (PVDF-TFE), polyvinylidene fluoride-chlorofluoroethylene (PVDF-CTFE), and polytetrafluoroethylene (PTFE).

The second anode active material may include at least one selected from the group consisting of a carbon-based active material, a silicon-based active material, a metal-based active material that may be alloyed with lithium, and a lithium-containing active material. In this case, the second anode active material may be the same as, or different from, the first anode active material.

The carbon-based active material may be, for example, graphite, hard carbon, soft carbon, or graphene. The graphite may be artificial graphite, natural graphite, a mixture of artificial graphite and natural graphite, natural graphite coated with artificial graphite, or a combination thereof.

The carbon-based active material has a little change in crystal structure in the process of intercalation and deintercalation of lithium ions, and may thus allow continuous and repeated redox reactions at an electrode to obtain a lithium secondary battery having high capacity and greater lifespan.

The silicon-based active material may be, for example, Si, SiOₘ, Si—C composite, Si-Q alloy, or a combination thereof, m satisfies 0<m≤2, Q may be an alkali metal, an alkaline earth metal, Group 13 to Group 16 elements, a transition metal, a rare earth element, or a combination thereof, and Si is excluded from Q.

The metal-based active materials that may be alloyed with lithium may be, for example, B, Al, Ga, In, Ge, Sn, Pb, P, As, Sb, Bi, Mg, Ca, Zn, Cd, Pd, Ag, Au, Pt, an alloy thereof, or an oxide thereof.

The lithium-containing active material may be, for example, lithium-containing titanium complex oxide (LTO).

The second conductive material may include at least one selected from the group consisting of graphite, active carbon, carbon black, acetylene black, Ketjen black, carbon nanotubes, graphene, and carbon fiber. In this case, the second conductive material may be the same as, or different from, the first conductive material.

### Laminate

The laminate may include the first self-standing film and the second self-standing film.

The first self-standing film may include the first binder containing the triblock copolymer, and have excellent mechanical properties derived from the first hard block and the second hard block of the triblock copolymer and excellent adhesion to a current collector through pi-pi interactions resulting from an aromatic ring structure included in the repeating units of the first hard block and the second hard block.

The second self-standing film may include the second binder containing a fluorine-based resin, and particularly, the second binder containing a fibrous fluorine-based resin may have excellent flexibility derived from the fibrous binder.

As described above, the first self-standing film and the second self-standing film include different types of binders, and accordingly, the first self-standing film and the second self-standing film may have different physical properties. That is, the first self-standing film may have greater mechanical properties and greater adhesion to a current collector than the second self-standing film, and the second self-standing film may have greater flexibility than the first self-standing film.

In this case, the laminate including both the first self-standing film and the second self-standing film may be well balanced with a combination of excellent mechanical properties derived from the first self-standing film, excellent adhesion to a current collector, and excellent flexibility derived from the second self-standing film.

In an embodiment, the laminate may have an average thickness of 30 μm to 500 μm, preferably 100 μm to 400 μm, and more preferably 150 μm to 250 μm. In this case, when the average thickness of the laminate satisfies the ranges described above, the laminate may obtain sufficient mechanical properties, and also obtain low resistance to have improved output characteristics when applied to lithium secondary batteries.

In an embodiment, the laminate may have various types of stack structures including the first self-standing film and the second self-standing film. For example, the laminate may have a double-layer structure in which the first self-standing film and the second self-standing film are sequentially stacked. For another example, the laminate may have a tri-layer structure in which the first self-standing film is stacked on each of an upper side and a lower side of the second self-standing film. For another example, the laminate may have a structure including repeated alternating stack structures of the first self-standing film and the second self-standing film (e.g., a four-layer structure of first self-standing film/second self-standing film/first self-standing film/second self-standing film or a stack structure with more than four layers overlapping). As such, when the laminate has a structure including repeated triple-layer structures or alternating stack structures, the laminate may have further improved physical properties as self-standing films having different physical properties are distributed uniformly throughout the laminate.

In an embodiment, the first self-standing film and the second self-standing film may be at a thickness ratio of 1:0.01 to 1:0.49, 1:0.05 to 0.42, 1:0.07 to 0.35, or 1:0.1 to 0.29. In this case, when the thickness ratio of the first self-standing film and the second self-standing film satisfies the ranges described above, the laminate may sufficiently secure excellent physical properties derived from each of the first self-standing film and the second self-standing film, and also the content of the triblock copolymer having excellent stability at negative potential may be sufficiently greater than the content of the fluorine-based resin having relatively low stability at negative potential compared to the triblock copolymer to further improve lifespan characteristics of a lithium secondary battery to which the laminate is applied.

### Anode for Lithium Secondary Battery

An anode for the lithium secondary battery of the present invention includes the self-standing film laminate for an anode of a lithium secondary battery described above, and a current collector.

The current collector is not particularly limited as long as the current collector is highly conductive without causing chemical changes in the anode. For example, stainless steel, aluminum, nickel, titanium, fired carbon, copper, an alloy thereof, or stainless steel that is surface-treated with one of carbon, nickel, titanium, silver, or the like may be used as the current collector.

The current collector may be disposed on a side of the first self-standing film as an outermost layer in the self-standing film laminate for an anode of a lithium secondary battery. As described above, the triblock copolymer included in the first self-standing film may have excellent adhesion to the current collector through pi-pi interactions resulting from the aromatic ring structure included in the repeating units of the first hard block and the second hard block, and accordingly, adhesion between the self-standing film laminate for an anode of a lithium secondary battery and the current collector may be improved when the current collector is disposed on the side of the first self-standing film.

In an embodiment, in the current collector, a primer layer containing a carbon-based material may be formed on a surface of a side where the self-standing film laminate for an anode of the lithium secondary battery is disposed. The carbon-based material may include, for example, at least one selected from the group consisting of graphite, graphene, carbon black, denka black, acetylene black, Ketjen black, channel black, furnace black, lamp black, thermal black, carbon nanotubes, graphite fiber, and carbon fiber.

The carbon-based material included in the primer layer may have excellent adhesion to the first self-standing film through pi-pi interactions with the aromatic ring structure included in the repeating units of the first hard block and the second hard block. Accordingly, when the primer layer is formed, adhesion between the self-standing film laminate for an anode of the lithium secondary battery and the current collector may be further improved.

### Lithium Secondary Battery

A lithium secondary battery of the present invention may include the anode for a lithium secondary battery above-described, a cathode for a lithium secondary battery, and an electrolyte.

The cathode for a lithium secondary battery may include at least one cathode active material selected from the group consisting of lithium, nickel, cobalt, manganese, iron, tin, silicon, aluminum, and a mixture thereof. For example, as for the cathode for a lithium secondary battery, cathode active materials such as LiCoO₂, LiMnO₂, LiFeO₂, Li(Ni_{0.6}Mn_{0.2}Co_{0.2})O₂, Li(Ni_{0.7}Mn_{0.15}Co_{0.15})O₂, Li(Ni_{0.8}Mn_{0.1}Co_{0.1})O₂, Li(Ni_{0.9}Mn_{0.05}Co_{0.05})O₂, LiNi_{0.6}Co_{0.2}OAl_{0.2}O₂, LiNi_{0.7}Co_{0.2}OAl_{0.1}O₂, LiNi_{0.8}Co_{0.15}Al_{0.05}O₂, LiNi_{0.85}Co_{0.1}Al_{0.05}O₂, LiNi_{0.88}Co_{0.1}Al_{0.02}O₂, LiMn₂O₄, and LifePO₄ may be applied.

The electrolyte may be a liquid electrolyte or a solid electrolyte.

When the electrolyte is a liquid electrolyte, the electrolyte may include a lithium salt and a non-aqueous organic solvent.

The lithium salt may be applied without limitation as long as the lithium salt is commonly used for the electrolyte of lithium secondary batteries. For example, the lithium salt may include at least one compound selected from the group consisting of LiPF₆, LiBF₄, LiSbF₆, LiAsF₆, LiN(C₂F₅SO₂)₂, LiN(CF₃SO₂)₂, CF₃SO₃Li, LiC(CF₃SO₂)₃, LiC₄BO₈, LiTFSI, LiFSI, and LiClO₄.

The non-aqueous organic solvent may include a type of organic solvent that may be usable as a non-aqueous electrolyte in manufacturing typical lithium secondary batteries. In this case, the non-aqueous organic solvent may be included in an amount that is appropriately regulated in a generally acceptable range.

Specifically, the non-aqueous organic solvent may include typical organic solvents that may be usable as non-aqueous organic solvents for lithium secondary batteries, such as cyclic carbonate solvents, linear carbonate solvents, ester solvents, or ketone solvents, and these solvents may be used either singly or in combination of two or more.

The cyclic carbonate solvent may include at least one selected from the group consisting of ethylene carbonate (EC), vinylene carbonate (VC), fluoroethylene carbonate (FEC), propylene carbonate (PC), and butylene carbonate (BC).

The linear carbonate solvent may include at least one selected from the group consisting of dimethyl carbonate (DMC), diethyl carbonate (DEC), dipropyl carbonate (DPC), ethylmethyl carbonate (EMC), methylpropyl carbonate (MPC), and ethylpropyl carbonate (EPC).

The ester solvent may include at least one selected from the group consisting of methyl acetate, ethyl acetate, propyl acetate, methyl propionate, ethyl propionate, γ-butyrolactone, γ-valerolactone, γ-caprolactone, δ-valerolactone, and ε-caprolactone.

Polymethylvinyl ketone and the like may be used as the ketone solvent.

When the electrolyte is a liquid electrolyte, the lithium secondary battery may further include a separator.

As the separator, a typically used porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, may be used alone or in a lamination therewith, or a typical porous nonwoven fabric, for example, a nonwoven fabric formed of high melting point glass fibers or polyethylene terephthalate fibers may be used, but the separator is not limited thereto. Furthermore, a coated separator including a ceramic component or a polymer component may be used to secure heat resistance or mechanical strength, and the separator having a single layer or multilayer structure may be used.

In this case, the porous separator may generally have a pore diameter of 0.01 to 50 μm, and have a porosity of 5 to 95%. In addition, the porous separator may generally have a thickness of 5 to 300 μm.

Meanwhile, when the electrolyte is a solid electrolyte, the electrolyte may be a polymer-based solid electrolyte, an oxide-based solid electrolyte, a sulfide-based solid electrolyte, or a mixture thereof.

The polymer solid electrolyte may include, for example, a polyether-based polymer, a polycarbonate-based polymer, an acrylate-based polymer, a polysiloxane-based polymer, a phosphazene-based polymer, a polyethylene derivative, an alkylene oxide derivative such as polyethylene oxide, a phosphoric acid ester polymer, poly agitation lysine, polyester sulfide, polyvinyl alcohol, polyvinylidene fluoride and a derivative thereof, a polymer containing an ionic dissociation group. In addition, the polymer electrolyte is a polymer resin, and may be, for example, a branched copolymer in which an amorphous polymer such as PMMA, polycarbonate, polysiloxane, and/or phosphazene is copolymerized with a PEO (poly ethylene oxide) main chain as a comonomer, a comb-like polymer resin, and a cross-linked polymer resin, and at least one type therefrom may be included.

The oxide-based solid electrolyte may be, for example, an LLZO-based compound, an LLTO-based compound such as Li₃ₓLa_{2/3-x}TiO₃, a LISICON-based compound such as Li₁₄Zn (GeO₄)₄, an LATP-based compound such as Li_{1.3}Al_{0.3}Ti_{1.7}(PO₄)₃, an LAGP-based compound such as (Li₁₊ₓGe₂₋ₓAlₓ(PO₄)₃), and a LIPON-based compound, but is not particularly limited thereto.

The sulfide-based solid electrolyte may include at least any one of Li₆PS₅Cl, Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂SLi₃PO₄—P₂S₅, Li₂S—P₂S₅—P₂O₅, Li₂S—P₂S₅—SiS₂, LizS—P₂S₅—SnS, Li₂S—P₂S₅—Al₂S₃, Li₂S—GeS₂, or Li₂S—GeS₂—ZnS, but is not particularly limited thereto.

### Method for Manufacturing Self-Standing Film Laminate for Anode of Lithium Secondary Battery

Hereinafter, a method for manufacturing the self-standing film laminate for an anode of a lithium secondary battery of the present invention will be described, and overlapping descriptions will not be given for the self-standing film laminate for an anode of a lithium secondary battery and components included therein.

The method for manufacturing the self-standing film laminate for an anode of a lithium secondary battery may include stacking the first self-standing film and the second self-standing film.

In an embodiment, the stacking may include calendering (rolling). That is, the first self-standing film and the second self-standing film may be subjected to overlapping, passing between a pair of rolls, and pressed and rolled to form the self-standing film laminate for an anode of a lithium secondary battery.

In this case, when the self-standing film laminate for an anode of a lithium secondary battery includes two or more first self-standing films and/or two or more second self-standing films (e.g., a triple layer structure of first self-standing film/second self-standing film/first self-standing film), the stacking may include disposing a plurality of self-standing films constituting the self-standing film laminate for an anode of a lithium secondary battery to overlap according to the stacking order, and then making the self-standing films pass between a pair of rolls for pressing and rolling. That is, the stacking of the first self-standing film and the second self-standing film may be alternately stacking the first self-standing film and the second self-standing film.

In an embodiment, the stacking of the first self-standing film and the second self-standing film may be performed at 50 to 160° C., 60 to 130° C., or 80 to 120° C., and preferably may be performed at a temperature that is equal to or higher than the first glass transition temperature and the second glass transition temperature each corresponding to the first hard block and the second hard block, and that is equal to or higher than the glass transition temperature of the fluorine-based resin. In this case, when the stacking of the first self-standing film and the second self-standing film is performed in the temperature ranges described above, the fluidity and molding properties of the first binder and the second binder are sufficiently secured during the stacking, and accordingly, the adhesion between the first self-standing film and the second self-standing film may be further improved.

In an embodiment, the method for manufacturing the self-standing film laminate for an anode of a lithium secondary battery may include a film fabrication process of independently fabricating the first self-standing film and the second self-standing film. That is, the method for manufacturing the self-standing film laminate for an anode of a lithium secondary battery may include stacking the first self-standing film and the second self-standing film that are separately manufactured through different film fabrication processes.

In an embodiment, the first self-standing film may be obtained by a film fabrication process using a composition for forming a first self-standing film containing the first anode active material, the first conductive material, and the first binder. In this case, the first binder in the composition for forming the first self-standing film may include particles of the triblock copolymer, which have an average diameter (D50) of 1 μm to 50 μm. The average diameter (D50) indicates a diameter corresponding to 50% of the volume cumulative distribution using measured a laser diffraction/scattering particle size distribution measurement instrument.

The first binder in the composition for forming the first self-standing film is substantially spherical, and may be true spherical or almost true spherical, and may specifically have an average sphericity of 0.7 to 1.0, preferably 0.8 to 1.0, and more preferably 0.9 to 1.0. That is, before manufacturing the first self-standing film, the particles of the first binder in the composition for forming the first self-standing film including the first binder may be dispersed in the composition for forming the first self-standing film while substantially maintaining the spherical form.

In this case, the sphericity of the first binder in the composition for forming the first self-standing film is a value obtained by measuring major and minor diameters of 10 randomly selected particles using images of binder particles observed through a scanning electron microscope (SEM), calculating the ratio of the minor diameter/major diameter of each particle, and determining the average value of the ratio of the minor diameter/major diameter, and the closer the sphericity is to 1, the more sphere-like the particle.

In an embodiment, the film fabrication process of the first self-standing film may be performed through calendering (rolling). That is, the composition for forming the first self-standing film including the first anode active material, the first conductive material, and the first binder may be subjected to passing between a pair of rolls, and pressed and rolled to form the first self-standing film.

In this case, at the beginning of the film fabrication process, contact takes place between the first binder containing the substantially spherical triblock copolymer and the first anode active material or the first conductive material by a high external force (shear force, tension force, and the like), and then as the external force decreases in the back-end of the film fabrication process, the distance between the first anode active materials or the first conductive materials increases, and thus the first binder containing the triblock copolymer in contact with a surface of the first anode active material or the first conductive material may flexibly be deformed while maintaining the bond to have a non-continuous columnar or wire-like linear form.

In an embodiment, the film fabrication of the first self-standing film may be performed at a temperature equal to or higher than the first glass transition temperature and the second glass transition temperature each corresponding to the first hard block and the second hard block. The first hard block and the second hard block form a crosslink (connection) through a physical bond having relatively low bonding energy, and thus may remain in the same form and size below the glass transition temperature, but may be easily molded above the glass transition temperature. Accordingly, when the film fabrication process of the first self-standing film is performed at a temperature equal to or higher than the first glass transition temperature and the second glass transition temperature, each hard block included in the triblock copolymer is flexibly deformed while maintaining a bond with the first anode active material or the first conductive material, and thus the first binder portion may provide a physical crosslinking point (connection point) having a linear (non-continuous columnar or wire-like) form to form a solid three-dimensional network structure around the point.

In an embodiment, the second self-standing film may be obtained by a film fabrication process using a composition for forming a second self-standing film containing the second anode active material, the second conductive material, and the second binder.

In an embodiment, the film fabrication process of the second self-standing film may be performed through calendering (rolling). That is, the composition for forming the second self-standing film including the second anode active material, the second conductive material, and the second binder may be subjected to passing between a pair of rolls, and pressed and rolled to form the second self-standing film.

In an embodiment, the film fabrication of the second self-standing film may be performed at 60 to 160° C., 70 to 150° C., or 75 to 145° C., preferably at a temperature equal to or higher than the glass transition temperature of the fluorine-based resin. In this case, when the film fabrication of the self-standing film is performed at the temperature described above, sufficient flexibility of the second binder may be obtained, and accordingly, the bond between the second binder and the second anode active material and/or the second conductive material is effectively maintained and also the second binder may be flexibly deformed to facilitate molding of the second self-standing film.

In an embodiment, the film fabrication process of the first self-standing film and the film fabrication process of the second self-standing film may each be performed using a dry method. That is, the first self-standing film and the second self-standing film are each manufactured in a dry manner, and the composition for forming the first self-standing film and the composition for forming the second self-standing film may each substantially include no solvent. When the film fabrication process is performed using a wet method, there is a limit to increasing a loading amount of an electrode due to a liquid slurry, and a network structure between the binder and the active material/conductive material may not be formed in some cases, but as the film fabrication process according to the present invention is performed using a dry method, a high electrode loading amount that allows high energy density is achievable and a network structure between the binder and the active material may be formed more effectively.

### Method for Manufacturing Anode for Lithium Secondary Battery

Hereinafter, a method for manufacturing an anode for a lithium secondary battery of the present invention will be described, and overlapping descriptions will not be given for the anode for a lithium secondary battery and components included therein.

The method for manufacturing an anode for a lithium secondary battery may include the method for manufacturing a self-standing film laminate for an anode of a lithium secondary battery described above, and disposing a current collector on a side of the first self-standing film as an outermost layer in the self-standing film laminate for an anode of a lithium secondary battery.

In an embodiment, the current collector may be disposed through calendering (rolling). That is, when the first self-standing film as the outermost layer in the self-standing film laminate for an anode of a lithium secondary battery and the current collector are disposed to be opposite to each other, the current collector and the self-standing film laminate for an anode of a lithium secondary battery may be subjected to passing between a pair of rolls, and pressed and rolled to form the anode for a lithium secondary battery.

In an embodiment, the disposing of the current collector (e.g., the calendering) may be performed at 80 to 200° C., 90 to 170° C., or 95 to 145° C., and preferably may be performed at a temperature that is equal to or higher than the first glass transition temperature and the second glass transition temperature each corresponding to the first hard block and the second hard block. In this case, when the disposing of the current collector is performed in the temperature ranges described above, sufficient adhesion may be obtained between the current collector and the first self-standing film.

Hereinafter, the present invention will be described in more detail through Examples. However, these embodiments are provided to assist understanding of the present invention, and the scope of the present invention is not limited to the embodiments in any sense.

### Example 1 Self-Standing Film Laminate for Anode of Lithium Secondary Battery in which First Self-Standing Film and Second Self-Standing Film are Stacked

### Manufacturing Example 1-1: Manufacture of First Self-Standing Film Containing SBS Binder

Graphite as an anode active material, carbon black as a conductive material, and SBS triblock copolymer as a binder (glass transition temperature of polystadiene block: 100° C., glass transition temperature of polybutadiene block: −100° C.) were mixed without a solvent at a mass ratio of 96:1:3.

The mixed powder was roll-pressed into a self-standing film, using a 2-roll press heated to 120° C.

### Manufacturing Example 1-2: Manufacture of Second Self-Standing Film Containing PTFE Binder

Graphite as an anode active material, carbon black as a conductive material, and PTFE as a binder were mixed without solvents at a mass ratio of 96:1:3.

The mixed powder was roll-pressed into a self-standing film, using a 2-roll press heated to 80° C.

### Manufacturing Example 1-3: Manufacture of Laminate

The first self-standing film (Manufacturing Example 1-1) and the second self-standing film (Manufacturing Example 1-2) were subjected to overlapping and then rolled using a 2-roll press heated to 100° C. to manufacture a laminate.

In this case, the manufactured laminate had an average thickness of 200 μm, and the first and second self-standing films included in the laminate were at a thickness ratio of 1:0.25.

### Comparative Example 1: Self-Standing Film for Anode of Lithium Secondary Battery Containing PTFE as Binder

Graphite as an anode active material, carbon black as a conductive material, and PTFE as a binder were mixed without solvents at a mass ratio of 96:1:3.

The mixed powder was rolled using a 2-roll press heated to 80° C. to fabricate a self-standing film having an average thickness of 200 μm.

### Reference Example 1: Self-Standing Film for Anode of Lithium Secondary Battery Containing SBS as Binder

Graphite as an anode active material, carbon black as a conductive material, and SBS triblock copolymer as a binder (glass transition temperature of polystadiene block: 100° C., glass transition temperature of polybutadiene block: −100° C.) were mixed without a solvent at a mass ratio of 96:1:3.

The mixed powder was rolled using a 2-roll press heated to 120° C. to fabricate a self-standing film having an average thickness of 200 μm.

### Experimental Example 1: SEM Image Observation of Mixed Powder in Manufacturing Example 1-1 and First Self-Standing Film Manufactured Therefrom

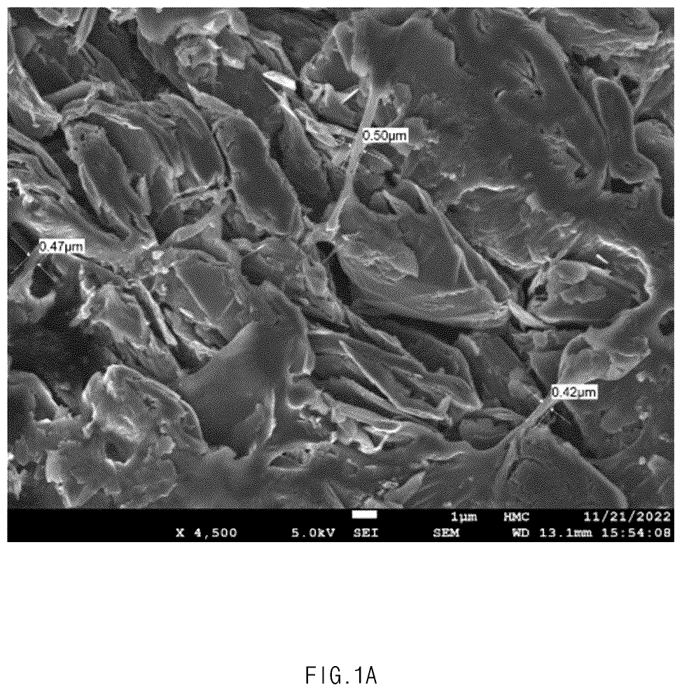

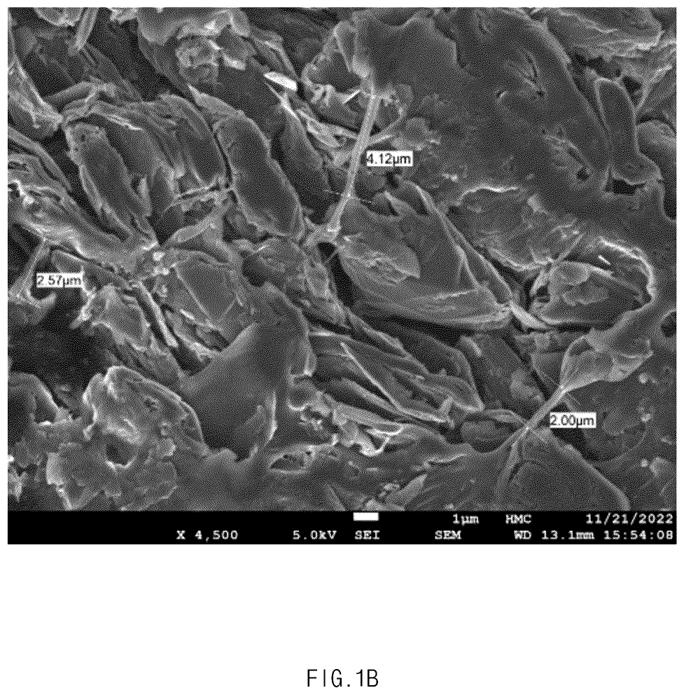

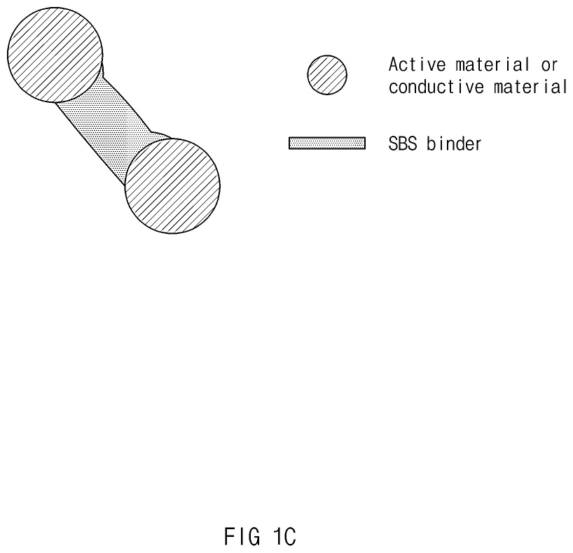

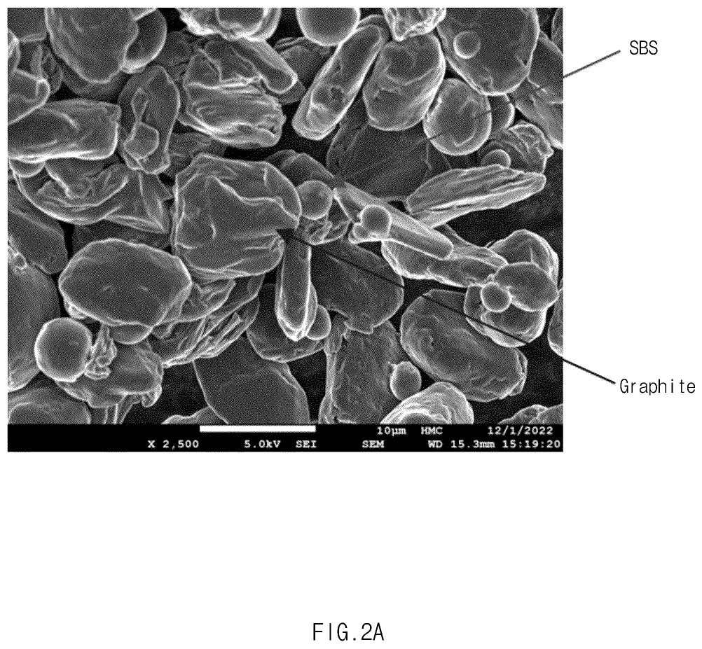

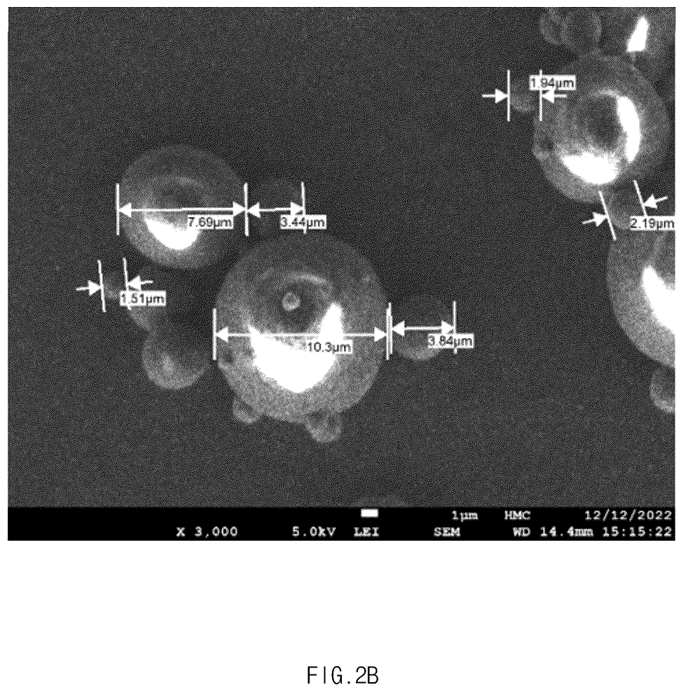

An SEM image was taken for the first self-standing film manufactured according to Manufacturing Example 1-1 and is shown in FIGS. 1A and 1B, and before manufacturing the first self-standing film, SEM images were taken for mixed powder of an anode active material (graphite), a conductive material (carbon black), and a binder (SBS triblock copolymer), and are shown in FIG. 2A, and in this case, the SEM image taken only for the SBS powder is shown in FIG. 2B.

Referring to FIGS. 1A and 1B, it is seen that after the film fabrication process, the columnar SBS binder forms a network structure connecting between anode active materials, between conductive materials, or between anode active materials and conductive materials, and is in the form of a column having an average width perpendicular to a longitudinal direction of about 0.4 to 0.5 μm.

FIG. 1C schematically shows a columnar SBS binder connecting any one of the anode active material or the conductive material and another one of the anode active material or the conductive material in the network structure of the first self-standing film manufactured according to Manufacturing Example 1-1. In this case, it is seen that the SBS binder in the form of a non-continuous column makes point contact with an outer surface of each of an active material domain or a conductive material domain, creating a structure connecting the domains.

Referring to FIG. 2A, it is seen that SBS is dispersed in the mixed powder while maintaining an almost spherical form (average diameter (D50): 8 D50/average sphericity: 0.95), and as shown in FIG. 2B, the SBS powder before manufacturing the mixed powder described above is also almost spherical.

### Experimental Example 2: Evaluation of Adhesion to Current Collector

A current collector (copper foil having a thickness of 8 μm from Nexilis) coated with a primer layer (Ketjen Black) and the self-standing film laminate of Example 1, the self-standing film of Comparative Example 1, and the self-standing film of Reference Example 1 were rolled using a 2-roll press heated to 100° C. to manufacture an anode for a lithium secondary battery. In this case, the first self-standing film included in the self-standing film laminate of Example 1 was disposed to face the primer layer coated on the current collector.

Thereafter, a peeling test was performed on the current collector and the self-standing film laminate or the self-standing film according to the standards of ASTM D1876, and the results are shown in Table 1 below.

### Experimental Example 3: Evaluation of Flexibility

A cylindrical bar having an average diameter of 10 mm was wrapped with the self-standing film laminate of Example 1, the self-standing film of Comparative Example 1, and the self-standing film of Reference Example 1, and then the occurrence of cracks was evaluated with the naked eye, and the results are shown in Table 1 below.

### Experimental Example 4: Evaluation of Tensile Strength and Elongation

To evaluate the tensile strength of the self-standing film laminate of Example 1, the self-standing film of Comparative Example 1, and the self-standing film of Reference Example 1, each self-standing film was punched to have a width of 2 cm and a height of 6 cm to prepare samples, and the samples were measured while being pulled at a rate of 5 mm/min using UTM equipment to obtain a strain-length dependence graph of stress, and based on the graph, the tensile strength and elongation were measured and the results are shown in Table 1 below.

In this case, the tensile strength was measured by dividing the tensile stress measured in the graph by the cross-sectional area of the sample, and the elongation was measured as the ratio of the strain length between the yield stress and tensile stress measured in the graph.

TABLE 1

| | | | Tensile | |
|---|---|---|---|---|
| | Adhesion | | strength | Elongation |
| | [gf/mm] | Flexibility | [MPa] | [ %] |
| Example 1 | 3 | Good | 0.7 | 2 |
| Comparative | 1.2 | Good | 0.1 | 5.5 |
| Example 1 | | | | |
| Reference | 3 | Poor | 0.7 | 2 |
| Example 1 | | | | |

Referring to Table 1, the self-standing film laminate of Example 1 was determined to have excellent adhesion to the current collector and excellent tensile strength.

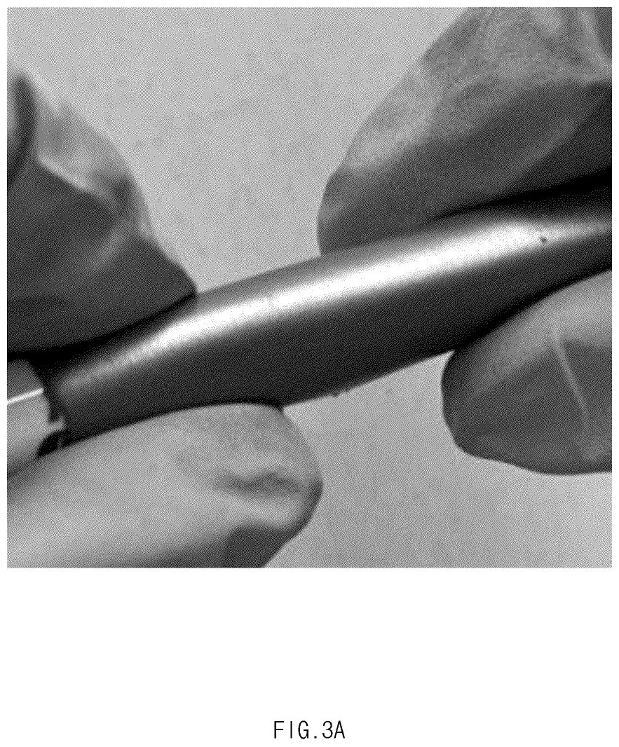

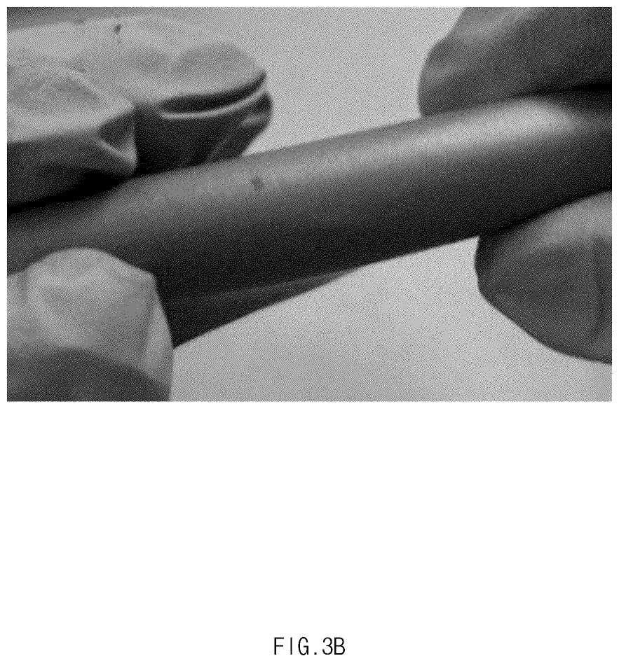

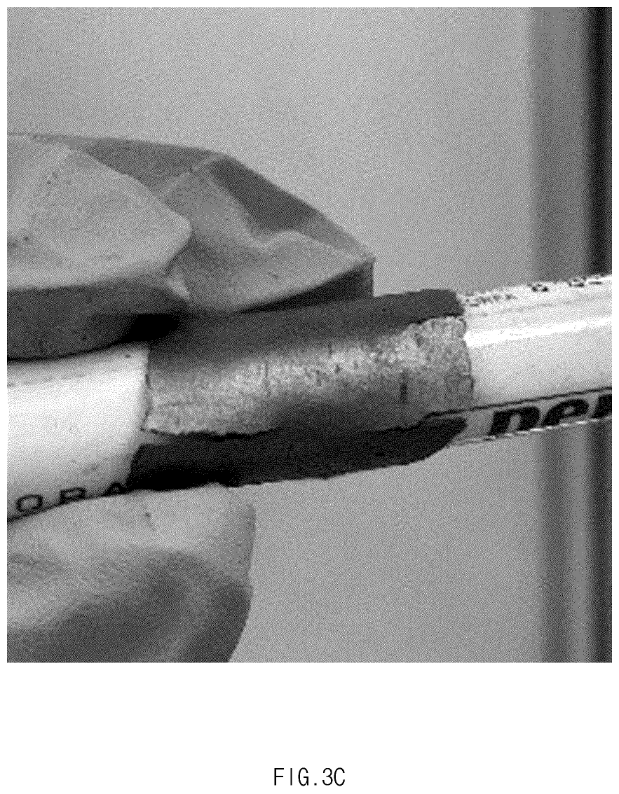

In addition, the self-standing film laminate of Example 1 was determined to have a relatively low elongation at a level suitable for application to a roll-to-roll process and to have excellent flexibility as well (see FIG. 3A).

In contrast, the self-standing film of Comparative Example 1 was determined to have excellent flexibility (see FIG. 3B), but to have poorer adhesion to the current collector and tensile strength than the self-standing film laminate of Example 1, and the self-standing film of Reference Example 1 was determined to have poorer flexibility (see FIG. 3C) and excessively higher elongation than the self-standing film laminate of Example 1.

### Experimental Example 5: Evaluation of Tensile Strength According to Width of Fabricated Film

The tensile strength of the self-standing film laminate of Example 1, the self-standing film of Comparative Example 1, and the self-standing film of Reference Example 1 was measured when the width of fabricated films was set to 100 mm, 200 mm, and 300 mm, and the results are shown in Table 2 below.

In this case, the tensile stress measured in Experimental Example 4 was multiplied by the cross-sectional area of the self-standing film laminate or the self-standing film each having a different width of fabricated films to measure the tensile strength.

TABLE 2

| Width of | Tensile strength [N] | | |
|---|---|---|---|
| fabricated film | | Comparative | Reference |
| [mm] | Example 1 | Example 1 | Example 1 |
| 100 | 12.6 | 1.65 | 16.1 |
| 200 | 25.2 | 3.3 | 32.2 |
| 300 | 37.8 | 4.95 | 48.3 |

Referring to Table 2, the self-standing film laminate of Example 1, like the self-standing film of Reference Example 1, showed excellent overall tensile strength regardless of the film fabrication width values of 100 mm, 200 mm, and 300 mm.

In contrast, the self-standing film of Comparative Example 1 showed inferior tensile strength at all film fabrication widths of 100 mm, 200 mm, and 300 mm, and this was less than the minimum tensile strength of 5 N for application to commonly used roll press equipment.

A self-standing film laminate for an anode of a lithium secondary battery of the present invention may have excellent adhesion derived from a triblock copolymer included as a binder in a first self-standing film, excellent mechanical properties and satisfactory elongation, and excellent flexibility derived from a fluorine-based resin included as a binder in a second self-standing film.

While the present invention has been shown and described in connection with the exemplary embodiments, it will be apparent to those skilled in the art that modifications and variations can be made without departing from the spirit and scope of the invention as defined by the appended claims.

What is claimed is:

1. A self-standing film laminate suitable for an anode of a lithium secondary battery, the self-standing film laminate comprising:
a first self-standing film comprising a first anode active material, a first conductive material, and a first binder comprising a triblock copolymer; and
a second self-standing film comprising a second anode active material, a second conductive material, and a second binder comprising a fluorine-based resin,
wherein the triblock copolymer comprises a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and
the first binder is in the form of a non-continuous column connecting between any one of i) a domain of the first anode active material or ii) a domain of the first conductive material and a) another one of a domain of the first anode active material or b) a domain of the first conductive material.

2. The self-standing film laminate of claim 1, wherein the first self-standing film and the second self-standing film are at a thickness ratio of 1:0.01 to 1:0.49.

3. The self-standing film laminate of claim 1, comprising a tri-layer structure in which the first self-standing film is stacked on each of an upper side and a lower side of the second self-standing film.

4. The self-standing film laminate of claim 1, comprising a repeated alternating stack structure of the first self-standing film and the second self-standing film.

5. The self-standing film laminate of claim 1, wherein the domain of the first anode active material or the domain of the first conductive material and the first binder which is in the form of a non-continuous column are connected to form a three-dimensional network structure.

6. The self-standing film laminate of claim 1, wherein the first binder has an average width perpendicular to a longitudinal direction of 0.1 μm to 2 μm.

7. The self-standing film laminate of claim 1, wherein a first glass transition temperature and a second glass transition temperature each corresponding to the first hard block and the second hard block are independently 50° C. to 120° C., and
a third glass transition temperature corresponding to the soft block is −120° C. to −50° C.

8. The self-standing film laminate of claim 1, wherein the soft block is derived aliphatic diene-based monomer comprising at least one selected from the group consisting of a butadiene-based monomer, a pentadiene-based monomer, and a hexadiene-based monomer.

9. The self-standing film laminate of claim 1, wherein the first hard block and the second hard block are each independently derived from an aromatic ring-containing ethylenically unsaturated monomer comprising at least one of a styrene-based monomer and an aromatic (meth)acryl-based monomer.

10. The self-standing film laminate for an anode of a lithium secondary battery of claim 1, wherein the fluorine-based resin comprises at least one selected from the group consisting of polyvinylidene fluoride (PVDF), polyvinylidene fluoride-hexafluoropropylene (PVDF-HFP), polyvinylidene fluoride-trifluoroethylene (PVDF-TrFE), polyvinylidene fluoride-tetrafluoroethylene (PVDF-TFE), polyvinylidene fluoride-chlorofluoroethylene (PVDF-CTFE), and polytetrafluoroethylene (PTFE).

11. An anode for a lithium secondary battery comprising:
a current collector; and
the self-standing film laminate for an anode of a lithium secondary battery according to claim 1,
wherein the current collector is disposed on a side of a first self-standing film as an outermost layer in the self-standing film laminate for an anode of a lithium secondary battery.

12. The anode for a lithium secondary battery of claim 11, wherein the current collector comprises a primer layer containing a carbon-based material formed on a surface of a side where the self-standing film laminate for an anode of a lithium secondary battery is disposed.

13. A lithium secondary battery comprising:
the anode for a lithium secondary battery of claim 11;
a cathode for a lithium secondary battery; and
an electrolyte.

14. A method for manufacturing a self-standing film laminate for an anode of a lithium secondary battery, the method comprising:
stacking a first self-standing film comprising a first anode active material, a first conductive material, and a first binder comprising a triblock copolymer, and a second self-standing film comprising a second anode active material, a second conductive material, and a second binder comprising a fluorine-based resin,
wherein the triblock copolymer comprises a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and
the first binder is in the form of a non-continuous column connecting between any one of a domain of the first anode active material or a domain of the first conductive material and another one of a domain of the first anode active material or a domain of the first conductive material.

15. The method of claim 14, wherein the first self-standing film is obtained by a film fabrication process using a composition for forming a first self-standing film containing the first anode active material, the first conductive material, and the first binder, and
the first binder in the composition for forming a first self-standing film comprises triblock copolymer particles having an average diameter (D50) of 1 μm to 50 μm.

16. The method of claim 15, wherein the first binder in the composition for forming a first self-standing film is spherical and comprises particles having an average sphericity of 0.8 to 1.0.

17. The method of claim 14, wherein the first self-standing film and the second self-standing film are obtained using a dry film fabrication process.

18. The method of claim 17, wherein the film fabrication of the first self-standing film is performed at a temperature equal to or higher than the first glass transition temperature and the second glass transition temperature each corresponding to the first hard block and the second hard block.

19. The method of claim 14, wherein the stacking of the first self-standing film and the second self-standing film comprises alternately stacking the first self-standing film and the second self-standing film.

20. A method for manufacturing an anode for a lithium secondary battery, the method comprising:
the method for manufacturing a self-standing film laminate for an anode of a lithium secondary battery according to claim 14; and
disposing a current collector on a side of the first self-standing film as an outermost layer in the self-standing film laminate for an anode of a lithium secondary battery.
